(19) United States
(12) Patent Application Publication
(10) Pub. No.: US 2017/0127280 A1
(43) Pub. Date: May 4, 2017

(54) SECURE HANDLING OF SECURE SOCKET LAYER ("SSL") TRAFFIC

(71) Applicant: Seven Networks, LLC, Marshall, TX (US)

(72) Inventors: Ari Backholm, Los Altos, CA (US); Michael Luna, Los Angeles, CA (US); Andrii Kokhanovskyi, Kiev (UA)

(21) Appl. No.: 15/402,183

(22) Filed: Jan. 9, 2017

Related U.S. Application Data
(63) Continuation of application No. PCT/US15/38705, filed on Jun. 30, 2015.
(60) Provisional application No. 62/022,614, filed on Jul. 9, 2014.

(51) Int. Cl. H04W 12/06; H04L 29/06; H04W 12/02; H04L 9/32

(52) U.S. Cl. CPC H04W 12/06; H04L 9/3263; H04L 63/0853; H04L 63/166; H04W 12/02; H04L 2209/80; H04L 2209/76; H04W 88/02

(57) ABSTRACT

The subject matter described herein includes methods, systems, and computer program products for using an optimization server located between a client mobile communications device and a content server for selectively optimizing traffic transmitted between the content server and the mobile device in an encrypted, decoded form. According to one method, a trusted component is established in a client mobile communications device by processing encrypted data in decoded form using the trusted component. Criteria is provided for determining mobile communications traffic to be optimized. A request for transmitting mobile communications traffic from a content server to a client mobile device is detected. It is determined whether the criteria is satisfied for the detected mobile communications traffic. In response to determining that the criteria is satisfied, a secure connection is established, via an optimization server, between a trusted component of the client mobile device and the content server.

### CROSS-REFERENCE TO RELATED APPLICATIONS

This application claims priority to PCT Patent Application No. PCT/US15/38705 filed on Jun. 30, 2015, which claims priority to U.S. Provisional Patent Application No. 62/022,614 filed on Jul. 9, 2014 entitled “Secure Handling of Secure Socket Layer (“SSL”) Traffic,” the entire contents of which is incorporated by reference herein.

### BACKGROUND

Field of the Invention

The present invention relates to secure handling of SSL traffic, and more specifically, to selectively extending access to encrypted data in decoded form for optimizing hypertext transport protocol secure (HTTPS) traffic.

Description of Related Art

Increasing numbers of Internet services are delivered over secure connections, typically secure sockets layer (SSL) and transport layer security (TLS). This presents a challenge to optimize these connections in a mobile network, as optimization may require handling of the content stream in a decoded form, which is available at the ends of the connection—at the mobile device, and at the content server. Content servers are typically not optimized for the needs to the mobile network and devices, which may not require as high bandwidth and fidelity as terminals in a fixed network, but whose wireless connection is very expensive compared to their fixed counterparts. At the same time, users are often not willing to provide unlimited access to the data that they are transmitting in a decrypted form because security from third parties is a primary reason why the content is encrypted.

Accordingly, a need exists for optimizing mobile communications traffic in decoded form while maintaining the security and encryption between the content server and the mobile communications device.

### BRIEF SUMMARY

According to one embodiment of the present invention, an optimization server can be used for selectively optimizing traffic transmitted between a content server and a mobile device in an encrypted, decoded form. According to one method, a trusted component is established in a client mobile communications device by processing encrypted data in decoded form using the trusted component. Criteria is provided for determining mobile communications traffic to be optimized. Communications traffic between a content server to a client mobile device is detected and it is determined whether the criteria is satisfied for the detected mobile communications traffic. In response to determining that the criteria is satisfied, a secure connection is established, via an optimization server, between a trusted component of the client mobile device and the content server. The optimization server is authenticated to the trusted component of the client mobile device. The trusted component shares, with the content server, information used by the optimization server for encrypting and decrypting the traffic. The optimization server optimizes the mobile communications traffic by applying one or more optimization algorithms to the mobile communications traffic. The optimization server may be configured to apply traffic management policies in addition to optimizing mobile communications traffic by applying one or more optimization algorithms to the mobile communications traffic

A system includes a trusted component of a mobile communications device and an optimization server. The trusted component is configured to detect communications traffic between a content server and a client mobile device. The trusted component determines whether criteria for determining mobile communications traffic to be optimized is satisfied for the detected mobile communications traffic, and shares information used for encrypting and decrypting the traffic with the content server. The optimization server is configured to establish a secure connection between the trusted component and the content server in response to determining that the criteria is satisfied. The optimization server authenticates with the trusted component of the client mobile device and optimizes the mobile communications traffic by applying one or more optimization algorithms to the mobile communications traffic.

### BRIEF DESCRIPTION OF THE SEVERAL VIEWS OF THE DRAWINGS

FIG. 1 is a flow diagram illustrating secure processing of SSL traffic according to an embodiment of the subject matter described herein.

FIG. 2 is a system diagram illustrating a client-based configuration for processing SSL traffic according to an embodiment of the subject matter described herein.

FIG. 3 is a system diagram illustrating a server-based configuration for processing SSL traffic according to an embodiment of the subject matter described herein.

FIG. 4 is a message sequence diagram illustrating a HTTPS video optimization flow according to an embodiment of the subject matter described herein.

FIG. 5 is a message sequence diagram illustrating an example of a Hello phase in a split SSL configuration if no fake certification is available locally according to an embodiment of the subject matter described herein.

FIG. 6 is a message sequence diagram illustrating an example of a local SSL handshake according to an embodiment of the subject matter described herein.

FIG. 7 is a message sequence diagram illustrating an example of a split SSL key exchange phase according to an embodiment of the subject matter described herein.

### DETAILED DESCRIPTION

The subject matter described herein includes selectively extending access to encrypted data in decoded form for optimizing images and videos in hypertext transport protocol secure (HTTPS) traffic. In contrast to conventional configurations which extended trust from a server component to a client, the present disclosure includes extending the trust from the client to the server.

For example, a trusted component may be established. The trusted component may be located in a mobile device such as a smartphone. Trust may be established by allowing the trusted component to handle/process encrypted data in decoded form. The trusted component can be included in the SSL/TLS stack in the mobile device or may be a separate program executed on the mobile device. The trust can be established either by the manufacturer of the device and/or by obtaining an explicit permission from the end user.

The trusted component may manage criteria of types of traffic that should be optimized. The criteria may be based on the application initiating the traffic, the destination of the traffic (e.g. host name or IP address), the content of the traffic (e.g. HTTPS request content), combinations of these, or user permissions for specific combinations of these.

The trusted component may also manage the traffic that is approved for optimization and establish a secure connection (e.g. SSL/TLS) with a content server via an optimization server. In one embodiment, by default, the optimization server may be not able to access the encrypted data in a decrypted form. For example, the optimization server may be implemented as a transparent proxy or as a web/socks proxy. The optimization server may optimize traffic on demand. If there is no need for optimization, the optimization server may simply monitor the traffic. Alternatively, the optimization server may act as a proxy server and may route traffic that may be optimizable to a different optimization server.

In one embodiment, the trusted component may route all traffic through the optimization server. In another embodiment, the trusted component may route traffic through the optimization server if certain criteria is met. The criteria may be based on the application initiating the traffic, the destination of the traffic (e.g. host name or IP address), the content of the traffic (e.g. HTTPS request content), or combinations of these criteria. Typically, the determination of whether the criteria is met may be performed before a secure connection is established. However, if the criteria is met only after already establishing a secure connection directly to the content server, the trusted component may re-establish the outbound connection so that the connection is routed through the optimization server. This process may be performed transparently to the application originating the traffic.

The optimization server may authenticate itself to the trusted component. Authentication can be achieved, by, for example, using one of: a pre-shared secret, a private-public key pair, or other method of authentication.

When traffic that should be optimized is observed and connection is routed through the optimization server, the trusted component may share information used by the optimization server to decrypt and encrypt the traffic on a per-connection basis. Typically, after the SSL/TLS handshake is performed and a session has been established, a session-specific key may be exchanged. Subsequent traffic may be encrypted using the session-specific key. The information shared by the trusted party would include the session-specific key. Such a session-specific key may be valid for the given session/connection.

In some circumstances, the content server may request renegotiation of the session key. In such a circumstance, the trusted party may re-share the new key with the optimization server so long as the criteria described above continues to be met.

The optimization server may then have access to the decrypted data in specific sessions/connections it is allowed to. The optimization server may utilize algorithms to, for example, reduce the sizes of images and videos to fit the screen of the mobile device. The algorithms used by the optimization server are not limited to optimization and can include any alteration of the data before sending the data to the mobile device.

Alternatively, the trusted component may directly alter the request that is sent out to the network. For example the trusted component may advance or delay requests to align them with other traffic. The trusted component may alter the request to cause the content source to perform beneficial actions. Beneficial actions can include indicating the screen dimensions or the amount of bandwidth available. The trusted component may respond from a local cache on the mobile device. The trusted component may also block the request from going out to the network.

As will be described herein, a client-side proxy (CSP) can be used to optimize secure (e.g., HTTPS) traffic between client applications and remote resources. The CSP may terminate secure connections locally and present fake certificates of remote servers to client applications. In one embodiment, the application/destination pair may be HTTPS whitelisted in order for secure traffic to be intercepted by the CSP. Conversely, blacklisted secure traffic may be streamed through the CSP without being decrypted or optimized. The subject matter described herein may also improve the security of mobile device communications by distributing the data necessary to perform attack on a secure connection and storing root certificate private keys into a secure, controlled environment.

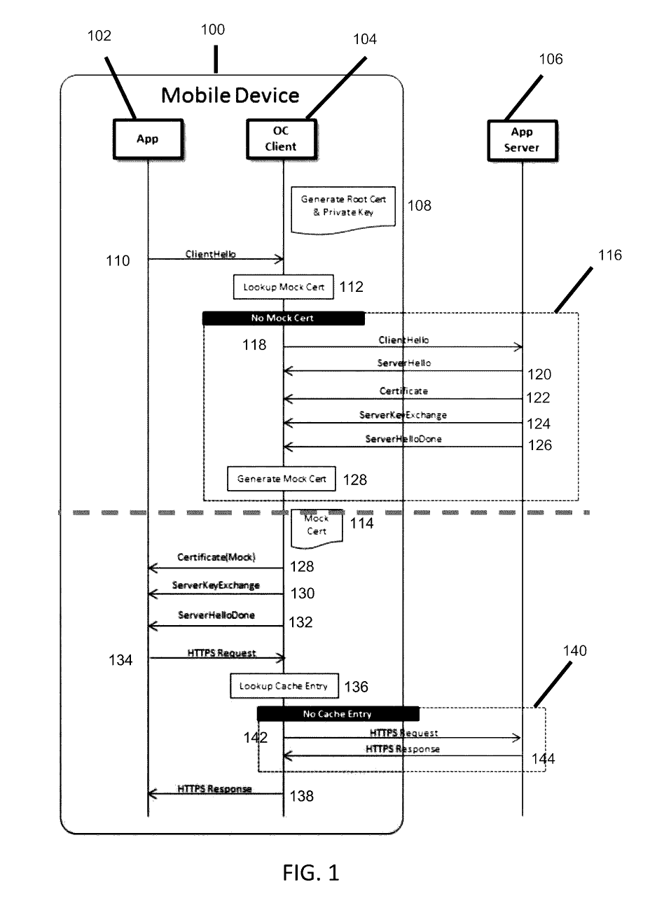

With reference now to FIG. 1, secure handling of SSL traffic between mobile device 100 and an application server 106 may include a setup phase between an application 102 running on the mobile device 100, an Open Channel (OC) client 104, and the application server 106. The setup phase may include determining a scope of application for SSL traffic optimization. This may include determining criteria or circumstances under which SSL traffic optimization is applied. In one embodiment, SSL traffic may be optimized when specific Android Package Names are configured for optimization. Otherwise, SSL traffic may pass untouched.

The setup phase may also include establishing a secure SSL proxy. In order to proxy secure a connection request (e.g., SSL or TLS) received from an application, at step 108 a device-specific root certificate and private key may be generated based on, for example, a random input. The root certificate can be stored with limited access. For example, the private key may be encrypted and an encryption key can be non-persistent and generated as-needed. The root certificate can also be stored using original equipment manufacturer (OEM) integration capabilities or by user permission. The private key can be used to create temporary “mock certificates” for originating servers that will then be trusted by the applications on the device, based on the presence of the root certificate in a keystore. Mock certificates may be generated with a fixed lifetime. Lastly, it may be appreciated that the use of per-device root certificate and private key described above may limit the risk of compromising the security of a mobile device if the device is lost or stolen. At step 110, the application 102 may send a ClientHello message to the OC Client 104. The OC Client, which may also include functionality of a trusted component or optimization server as described in greater detail below with respect to various embodiments, may perform a Mock Certificate lookup at step 112.

After setup, secure handing of SSL traffic may begin by using a mock certificate at step 114 to complete the SSL handshake. For example, upon receiving a SSL or TLS ClientHello message from an application on the mobile device, if the client has a valid mock certificate 114 for the destination specified in the ClientHello message, the client can use the mock certificate 114 to complete SSL handshake with the application.

If, however, a valid mock certificate is not present on the device 100, alternative steps 116 may be performed where the client 104 can initiate a secure connection request with the origin server 106 to obtain the origin server's 106 Public Certificate to generate a temporary mock certificate for the origin server 106. For example, alternative steps 116 which are associated with no mock certificate being present on the mobile device 100 may begin at step 188 when the client 104 sends a ClientHello message 118 to server 106. The server 106 responds with ServerHello message 120, Certificate 122, ServerKeyExchange 124, and ServerHelloDone message 126. The process concludes with generating a mock certificate at step 128, as opposed to successfully locating the mock certificate 114 in lookup step 112.

Once a mock certificate has been obtained, SSL proxy operation may be performed. From the application's perspective, the client may present itself as the origin server. From the perspective of the origin server, the client may present itself as the application. Instead of a single, end-to-end secure connection between the application and the origin server, there may thus be two secure connections—a first secure connection between the application and the client and a second secure connection between the client and the origin server. Once the SSL handshake phase is complete, the application can send a HTTPS request to the client. The process may then proceed in the same manner as an unsecure HTTP request, including applying client caching strategies.

For example, at steps 128, 130, and 132, respectively, a mock certificate, a ServerKeyExchange, and a ServerHelloDone message may be sent from the client 104 to the app 102. At step 136, the client 104 performs a Lookup Cache Entry. If no cache entry is found, steps 140 may be performed which include sending an HTTPS request message 142 to the server 106 and receiving an HTTPS Response message 144 containing the entry. At step 138, the HTTPS Response is forwarded from the client 104 to the application 102.

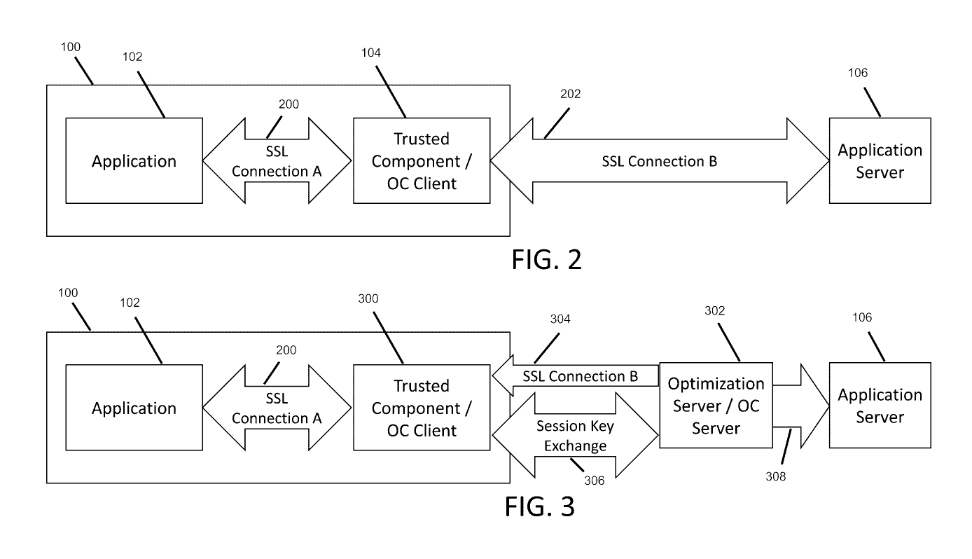

With reference now to FIG. 2, a client-based configuration for processing SSL traffic is shown. Processing SSL traffic can include performing HTTPS video and image optimization. Optimizing HTTPS videos and images may require processing the SSL traffic at the network server. According to the subject matter described herein, however, the point of processing the SSL traffic may be shifted on-demand between the client and the server securely within an SSL session. For example, an SSL connection may be routed, on-demand, through the server, and necessary information is shared within the connection for the server to decrypt/encrypt data specifically in that connection.

For example, mobile device 100 may include application 102 and open channel client 104 (aka trusted component 104) between which a first SSL connection may be made (e.g., SSL Connection A 200).

With reference now to FIG. 3, a server-based configuration for processing SSL traffic is shown. Similar to the configuration shown in FIG. 2, a first SSL connection (i.e., SSL Conn A 200) may be established between an application 102 and an open channel client 300 (i.e., trusted component) located on the mobile device 100. The open channel client 300 may then establish, via an open channel server 302 (i.e., optimization server), a second SSL connection 304 (i.e., SSL Conn B) with an application server 106 (i.e., content server). The open channel client 300 may also perform a session key exchange 306 with the open channel server 302 as described in greater detail herein. Using the server-based configuration shown in FIG. 3 may allow for downstream traffic optimization.

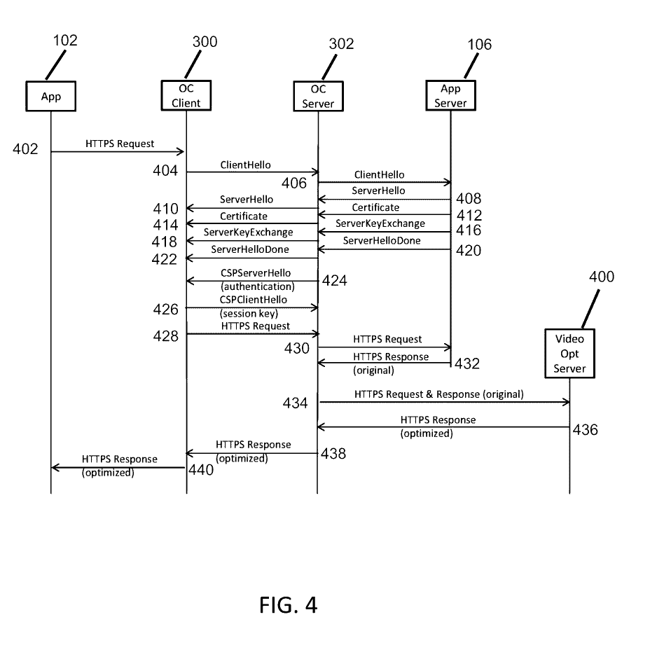

With reference now to FIG. 4, an application 102 may send an HTTPS request 402 to a client 300 (i.e., trusted component, “OC Client” in the drawings). The client 300 may send a ClientHello message 404 to an optimization server 302 (“OC Server” in the drawings), which relays the message to an application server 106 at step 406. The application server 106 may respond to the ClientHello message by returning a ServerHello message 408 to the optimization server 302. The optimization server 302 may then forward the ServerHello message 410 to the client 300. The application server 302 may also provide a certificate 412 and a ServerKeyExchange message 416 to the server 302, which the server 302 may forward to the client 300 as messages 414 and 418, respectively. After the key exchange is completed, the application server 106 may send a ServerHelloDone message 420 to the server 302, which may be forwarded to the client at step 422 indicating that the Hello phase of the flow is completed.

The server 302 may then send a CSPServerHello authentication message 424 to the client 300. The client 300 may respond by providing a CSPClientHello message 426 containing a session key to the server. The client 300 may then provide the HTTPS request message 428 sent by the application 102 to the server 302. The server 302 may forward the HTTPS request 430 to the application server 106, which may provide an un-optimized HTTPS response message 432 to the server 302. The server 302 may then forward the un-optimized HTTPS request and response messages 434 to a video optimization server 400. The video optimization server 400 may return an optimized HTTPS response 436 to the server 302, which is relayed to the client 300 as optimized HTTPS response 438, and then relayed to the application 102 as optimized HTTPS response 440.

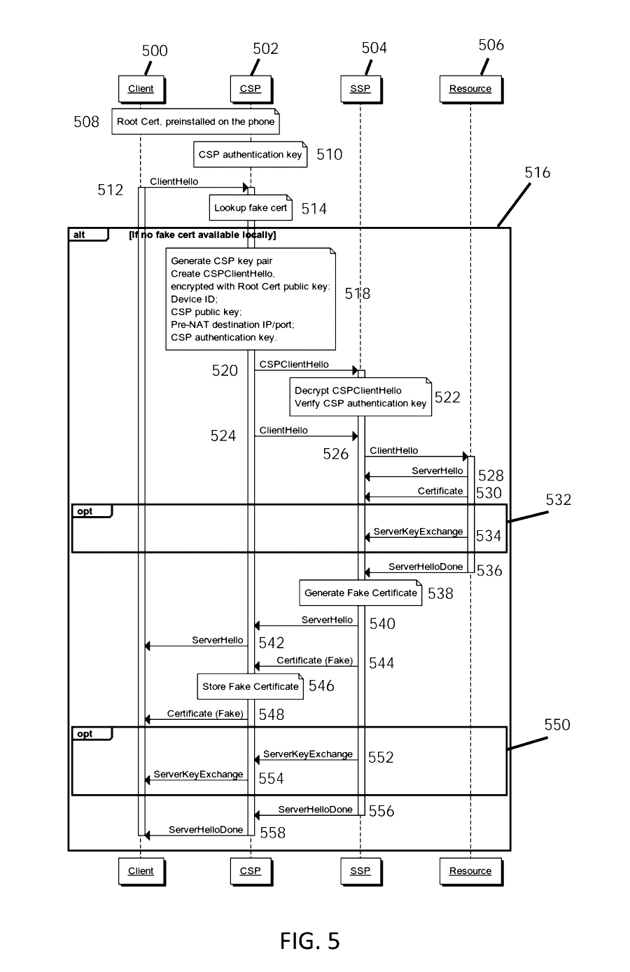

FIG. 5 is a message sequence diagram illustrating an example of a Hello phase in a split SSL configuration if no fake certification is available locally according to an embodiment of the subject matter described herein. With reference now to FIG. 5, the following components may participate in Split SSL communication: a client 500 (e.g., an application on a phone configured to initiate an HTTPS connection), a client-side proxy (CSP) 502, Server-Side SSL Proxy 504 (SSL SSP), and a resource 506 (e.g., a remote HTTPS resource).

Fake certificates for resources may be generated by the SSL SSP 504. Generation of fake certificates may use the root certificate's private key. Fake certificates may be validated with the root certificate. In one embodiment, each client device may have a root certificate pre-loaded into a keystore.

In some embodiments, the CSP 502 may not include fake certificate generation capability. However, in such embodiments the CSP 502 may persist fake certificates and corresponding private keys in a database. Persisted certificates may be used to terminate the client connection locally and serve data from cache. Depending on the availability of the fake certificate and corresponding private key, the CSP 502 may decide between performing a split handshake or a local handshake.

The Hello phase may begin when a client 500 opens a connection to a Resource 506. For example, at step 508 a root certificate is preinstalled on the mobile phone 100 and a CSP authentication key is generated and/or stored on CSP 502 at step 510. The CSP 502 may intercept the connection and recognize an SSL/TLS protocol based on a ClientHello message 512. The CSP 502 may then look up a fake certificate in a database at step 514. A split handshake may be performed when there is no fake certificate (and corresponding private key) available. For example, steps 516 may be performed if no fake certificate is available locally.

The Hello phase can extend a standard handshake procedure by preceding the standard messages with a CSPClientHello extension message. The message may be encrypted with a root certificate public key. The message may contain one or more of: a device ID (e.g., IMEI or MEID), a CSP public key (e.g., a key-pair is generated on HTTPS dispatcher start-up and stored in memory), a pre-NAT destination IP address and TCP port, a CSP authentication key (e.g., used to verify authenticity of the client). For example, at step 518, the CSP 502 may generate a CSP key pair, create a CSPClientHello message encrypted with the root certificate public key, device ID, CSP public key, pre-NAT destination IP/port address, and CSP authentication key. At step 520, the CSP 502 sends a CSPClientHello message to SSP 504. The SSP 504 decrypts the CSPClientHello message and verifies the CSP authentication key at step 522. The CSP 502 then sends ClientHello message 524 to the SSP 504, which the SSP 504 forwards to the resource 506 as ClientHello message 526. The resource 506 responds with ServerHello message 528 and Certificate 530. Optionally, at step 532, the resource may send a ServerKeyExchange message 534 to the SSP 504.

Next, ServerHelloDone message 536 may be sent from the resource 506 to the SSP 504 where SSP 504 generates a fake certificate 538. The SSP 504 then sends ServerHello message 540 to CSP 502, which forwards the message as ServerHello message 542 to client 500. The SSP 504 also sends the fake certificate to the CSP 502 where the CSP 502 stores the fake certificate at step 546. Optionally, steps 550 may be performed which include the CSP 502 receiving ServerKeyExchange message 552 from SSP 504 and forwarding ServerKeyExchange message 554 to the client 500.

The Hello phase may finish after a ServerHelloDone message 556 is sent from SSP 504 to CSP 502 and finally when ServerHelloDone message 558 is sent to the client 500. At the end of the Hello phase, the fake certificate 538 may be presented to the client 500 and stored at CSP 502 (e.g., without the corresponding private key). The fake certificate 538 may be indexed by the CSP 502 using hostname (as determined by the ClientHello SNI field) or by a pre-NAT destination IP address in case of SNI absence.

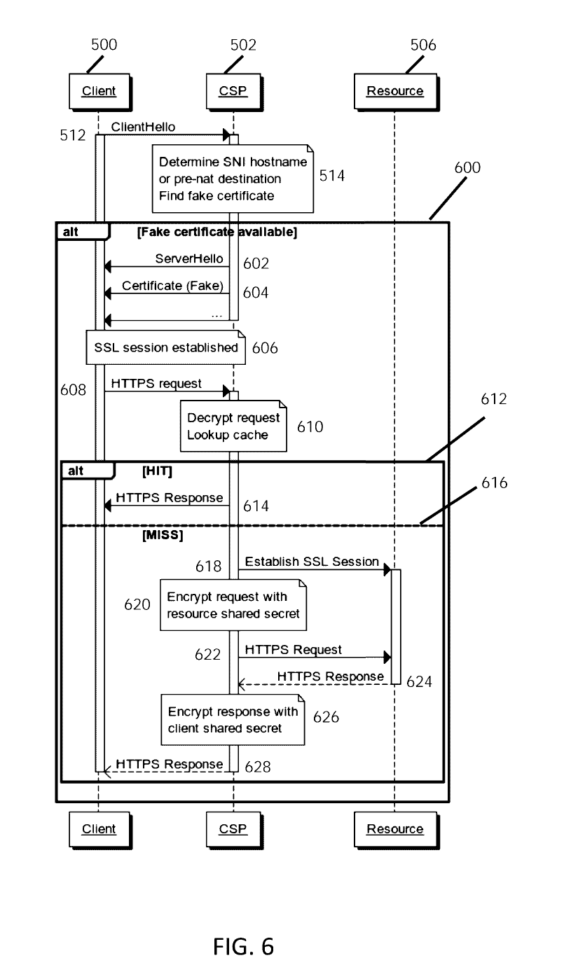

FIG. 6 is a message sequence diagram illustrating an example of a local SSL handshake according to an embodiment of the subject matter described herein. With reference now to FIG. 6, a key exchange phase may start after a successful Hello phase is initiated by a ClientKeyExchange message from client 500 to CSP 502. The ClientKeyExchange may be encrypted and the CSP 502 may determine the type of message. The CSP 502 may then forward the message to the SSL SSP 504. FIG. 6 illustrates an example of a message exchange during the key exchange phase. At the end of the key exchange phase, the SSL SSP 504 may send a CSPServerHello extension message to the CSP 502. The CSPServerHello extension message may contain information used to initialize SSL encoder/decoder contexts in the HTTPS dispatcher for decrypting/encrypting the application data.

An operation phase may start after a successful key exchange phase. During the operation phase, the CSP 502 may perform one or more of the following: decryption/encryption of the data from/to the client, data optimization, and encryption/decryption the data to/from the resource. The SSL SSP may function transparently and may not observe any unencrypted application data.

The fake certificate's private key may remain unknown to the CSP 502 until the CSP 502 makes a decision to cache application data. At this point, the CSP 502 may determine whether it already has a fake certificate with private key for the resource, and if not, may request the private key from the SSP 504. Request is sent with a CSPKeyRequest Split SSL extension message. The SSL SSP 504 then filters out this message from the flow and responds with a CSPKeyResponse message, which contains a private key for the fake certificate on the connection. Upon receiving CSPKeyResponse, the CSP 502 may parse out the certificate expiration date and store the fake certificate and private key in the database for the certificate validity period.

When the resource 506 closes the connection, the SSP 504 may determine whether the CSP 502 has requested the private key over the connection. If the CSP 502 has requested the private key over the connection, the SSP 504 may close the connection to the CSP 502. Otherwise, instead of closing the connection, the SSP 504 may send a CSPSocketCloseAlert Split SSL extension message to the CSP 502. The CSPSocketCloseAlert Split SSL extension message may indicate the requested socket close condition. This can provide the CSP 502 an opportunity to request the private key if the cached resource was the last (or the only) resource in the session. After a CSPSocketCloseAlert message is sent, the CSP 502 may be responsible for closing the connection. If the CSP 502 does not close the connection, the SSP 504 may close the connection after a configurable time-out.

For example, beginning at step 512, client 500 sends ClientHello message to CSP 502 and, at step 514, CSP 502 then determines an SNI hostname or pre-network address translation (NAT) destination and locates a fake certificate. Steps 600 may be performed if a fake certificate is available as a result of the lookup performed in step 514. Steps 600 may begin when CSP 502 sends ServerHello message 602 and the fake certificate 604 to client 500. An SSL session is established at step 606 as a result. Thereafter, client 500 sends an HTTPS request 608 to the CSP 502 and, at step 610, the CSP 502 decrypts the request 608 and performs a lookup in cache for an entry. If the cache lookup 610 finds a hit steps 612 may be performed. Alternatively, if the cache lookup 610 fails to find a hit (i.e., a miss) steps 616 may be performed. If a hit is found, the CSP 502 may simply provide an HTTPS Response message 614 to the client 500 corresponding to the received HTTPS Request message 608. However, if the lookup is a miss, the CSP 502 may establish an SSL session 618 with the resource 506. At step 620, the CSP 502 may encrypt the request with a resource shared secret as described herein. Thereafter, the CSP sends HTTPS Request 622 to the resource 506, which responds by returning HTTPS Response 624 to the CSP 502. The CSP 502 can then, at step 626, encrypt the response with the client shared secret and, at step 628, send HTTPS Response 628 to the client.

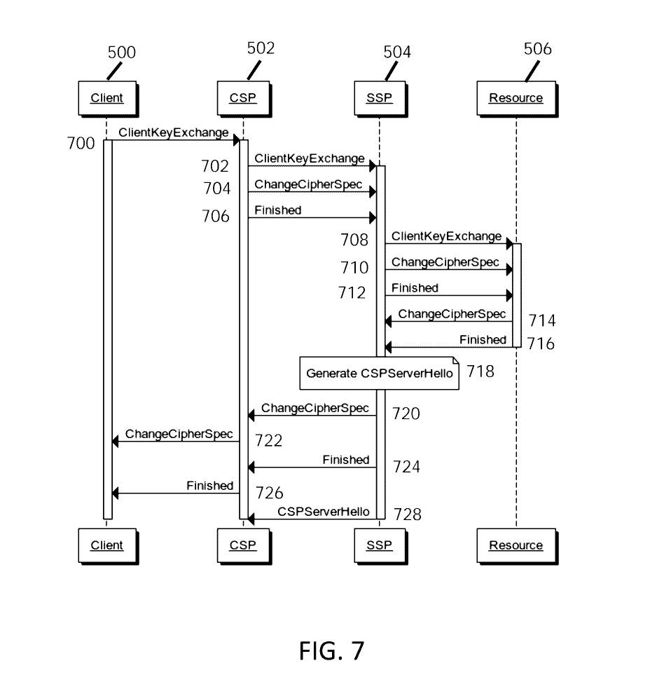

FIG. 7 is a message sequence diagram illustrating an example of a split SSL key exchange phase according to an embodiment of the subject matter described herein. With reference now to FIG. 7, the local handshake procedure may start upon detecting a new incoming connection from the client. It may be appreciated that, in contrast to FIG. 6 where no fake certificate is available, the CSP 502 in FIG. 7 has a fake certificate for the remote resource available and the fake certificate has not expired. However, in case a fake certificate is expired, the CSP 502 may remove the certificate, private key, and all associated cache entries, and initiate a handshake procedure. In the local handshake scenario shown in FIG. 7, the SSL SSP 504 may not be used. Message exchange during the local handshake may be similar to a standard SSL handshake, except that a fake resource certificate may be presented to the client.

For example, client 500 may send ClientKeyExchange message 700 to CSP 502. CSP 502 may then forward ClientKeyExchange message 702 to SSP 504 along with ChangeCipherSpec message 704 and Finished message 706. The SSP 504 then sends ClientKeyExchange message 708, ChangeCipherSpec message 710, and Finished message 712 to Resource 506. Resource 506 responds by returning Finished message 716 to SSP 504. The SSP 504 generates a CSPServerHello at step 718 and sends a ChangeCippherSpec message to CSP 502 at step 720. The CSP 502 forwards ChangeCipherSpec 722 to the client 500 along with Finished message 726 (which was received from SSP 504 as Finished message 724). Finally, SSP sends CSPServerhello message 728 to CSP 502.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
establishing a trusted component in a client mobile communications device by processing encrypted data in decoded form using the trusted component;
providing criteria for determining mobile communications traffic to be optimized;
detecting a request for transmitting mobile communications traffic from a content server to a client mobile device;
determining whether the criteria is satisfied for the detected mobile communications traffic;
in response to determining that the criteria is satisfied, establishing a secure connection between the trusted component of the client mobile communications device and the content server via an optimization server;
authenticating the optimization server to the trusted component of the client mobile device;
sharing, by the trusted component, information used by the optimization server for encrypting and decrypting the traffic with the content server; and
optimizing, by the optimization server, the mobile communications traffic by applying one or more optimization algorithms to the mobile communications traffic.

2. The method of claim 1, wherein establishing a trusted component includes establishing the trusted component as part of an secure socket layer/transport layer security (“SSL/TLS”) stack.

3. The method of claim 1, wherein providing the criteria includes providing criteria based on one or more of: an initiation of the traffic by an application, a destination identifier of the traffic, or a content of the traffic.

4. The method of claim 1, wherein establishing a secure connection includes establishing one of a secure socket layer (“SSL”) or transport layer security (“TLS”) connection.

5. The method of claim 1, wherein the optimization server includes one of a transparent proxy, web, or a socket secure (“SOCKS”) proxy server.

6. The method of claim 1, further comprising routing the traffic through the optimization server regardless of whether the criteria is satisfied.

7. The method of claim 1, wherein optimizing the mobile communications traffic by the optimization server includes optimizing the traffic on demand.

8. The method of claim 1, further comprising monitoring the traffic when optimization is not performed.

9. The method of claim 1, wherein authenticating the optimization server includes using one of: a pre-shared secret or a private-public key pair.

10. The method of claim 1, wherein the determination of whether the criteria is met is performed before the secure connection is established.

11. The method of claim 1, wherein the determination of whether the criteria is met is made after establishing a secure connection directly to the content server, the trusted component re-establishes the outbound connection such that the connection is routed through the optimization server.

12. A system comprising:
a trusted component of a client mobile communications device configured to detect a request for transmitting mobile communications traffic from a content server to a client mobile device, to use, to determine whether criteria for determining mobile communications traffic to be optimized is satisfied for the detected mobile communications traffic, and to share information used for encrypting and decrypting the traffic with the content server; and
an optimization server configured to establish a secure connection between the trusted component of the client mobile communications device and a content server in response to determining that the criteria is satisfied, to authenticate with the trusted component of the client mobile device, and to optimize the mobile communications traffic by applying one or more optimization algorithms to the mobile communications traffic.

13. The system of claim 12, wherein the trusted component is located at a mobile device.

14. The system of claim 12, wherein the trusted component includes one of an socket layer/transport layer security (“SSL/TLS”) stack or a dedicated program.

15. The system of claim 12, wherein the trusted component is configured to provide the criteria to the optimization server based on one or more of: an initiation of the traffic by an application, a destination identifier of the traffic, or a content of the traffic.

16. The system of claim 12, wherein the trusted component is configured to establish the secure connection with the optimization server by establishing one of a secure socket layer (“SSL”) or transport layer security (“TLS”) connection.

17. The system of claim 12, wherein the optimization server includes one of a transparent proxy, web, or a socket secure (“SOCKS”) proxy server.

18. The system of claim 12, wherein the trusted component is configured to route the traffic through the optimization server regardless of whether the criteria is satisfied.

19. The system of claim 12, wherein the optimization server is configured to optimize the mobile communications traffic by optimizing the traffic on demand.

20. A computer program product for secure handling and optimizing of secure socket layer (“SSL”) traffic, said computer program product comprising:
a computer readable storage medium having computer readable program code embodied therewith, the computer readable program code comprising computer readable program code configured to:
establish a trusted component in a client mobile communications device by processing encrypted data in decoded form using the trusted component;
provide criteria for determining mobile communications traffic to be optimized;
detect a request for transmitting mobile communications traffic from a content server to a client mobile device;
determine whether the criteria is satisfied for the detected mobile communications traffic;
establish a secure connection between a trusted component of the client mobile device and the content server via an optimization server in response to determining that the criteria is satisfied;
authenticate the optimization server to the trusted component of the client mobile device;
share, by the trusted component, information used by the optimization server for encrypting and decrypting the traffic with the content server; and
optimize, by the optimization server, the mobile communications traffic by applying one or more optimization algorithms to the mobile communications traffic.
